(19) United States
(12) Patent Application Publication
(10) Pub. No.: US 2026/0039761 A1
(43) Pub. Date: Feb. 5, 2026

(54) IMAGE READING DEVICE AND IMAGE FORMING APPARATUS

(71) Applicant: CANON KABUSHIKI KAISHA, Tokyo (JP)

(72) Inventor: MASAHITO IKEDA, Saitama (JP)

(21) Appl. No.: 19/282,383

(22) Filed: Jul. 28, 2025

(30) Foreign Application Priority Data
Aug. 5, 2024 (JP) 2024-128670

(51) Int. Cl. H04N 1/12; G03G 15/22; H04N 1/00

(52) U.S. Cl. CPC H04N 1/1245; G03G 15/228; H04N 1/00615; H04N 1/00795; H04N 1/1215; H04N 2201/0081

(57) ABSTRACT

An image reading device includes a reading unit that includes a transparent member, a sensor for reading an image on a sheet conveyed by a conveyance roller via the transparent member, a case accommodating the sensor, and a first contact portion and a second contact portion located at the case. The reading unit is movable to each of a first position where the image on the sheet is read by the sensor and a second position where the transparent member is exposed to an outside and the first and second contact portions contact the conveyance unit. When the transparent member is pressed in a state where the reading unit is located at the second position, a backup portion contacts the other of the case and the conveyance unit so that the conveyance unit supports the case.

### BACKGROUND

### Field of the Technology

The present disclosure relates to an image reading device for reading an image on a sheet, and an image forming apparatus.

### Description of the Related Art

An automatic document feeder (ADF) that is configured to automatically convey a document to an image reading unit and includes a reading unit for reading an image on a back surface of each sheet so that images on both surfaces of each sheet can be read in one document conveyance operation has recently been proposed (see Japanese Patent Application Laid-Open No. 2023-4032). Such an ADF has a configuration in which the reading unit provided in the ADF can be rotated to expose a glass surface provided on the reading unit to an outside so as to clean the glass surface.

However, there is a possibility that, for example, when the glass surface is pressed with great force, for example when the glass surface is cleaned, flexure occurs at or beyond an acceptable level on the reading unit that may deform the reading unit. The deformation of the reading unit can degrade the accuracy of image reading or cause a failure, such as a document conveyance failure.

### SUMMARY

Accordingly, the present disclosure is directed to providing an image reading device and an image forming apparatus capable of reducing deformation of a reading unit.

An aspect of the present disclosure provides an image reading device that includes a conveyance unit including a conveyance roller configured to convey a sheet; and a reading unit including a transparent member, a sensor configured to read an image on the sheet conveyed by the conveyance roller via the transparent member, a case configured to accommodate the sensor, and a first contact portion and a second contact portion that are located at the case. The reading unit is movable to each of a first position and a second position. The image on the sheet is read by the sensor with the reading unit in the first position. The transparent member is exposed to an outside and the first contact portion and the second contact portion contact the conveyance unit with the reading unit in the second position. One of the case and the conveyance unit is provided with a backup portion located between the first contact portion and the second contact portion in a longitudinal direction of the case. In a case where the transparent member is pressed in a state where the reading unit is located at the second position, the backup portion contacts the other of the case and the conveyance unit so that the conveyance unit supports the case.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic view illustrating an image forming apparatus according to an exemplary embodiment of the present disclosure. FIG. 1B is a schematic view illustrating a document reading device.

FIG. 2 is a side view illustrating a part of an automatic document feeder (ADF) according to the exemplary embodiment.

FIG. 3 is a sectional view illustrating a reading unit according to the exemplary embodiment and a peripheral portion thereof.

FIG. 4 is a cross sectional view taken along a line A-A illustrated in FIG. 2.

FIG. 5A illustrates a state where opening of a rotation guide is started. FIG. 5B illustrates a state where opening of the reading unit is started by opening the rotation guide.

FIG. 6 illustrates a state where the reading unit has moved to a maintenance position.

FIG. 7 is a perspective view illustrating a conveyance guide of a device body and the reading unit located at a reading position.

FIG. 8 is a perspective view illustrating the conveyance guide of the device body and the reading unit located at the maintenance position.

FIG. 9A is a top view illustrating the conveyance guide of the device body and the reading unit located at the maintenance position. FIG. 9B is a cross sectional view taken along a line B-B illustrated in FIG. 9A.

FIG. 10 is a schematic view illustrating a state where the reading unit located at the reading position is pressed by pressing portions.

### DESCRIPTION OF THE EMBODIMENTS

Exemplary embodiments of the present disclosure will be described below with reference to the drawings.

### Image Forming Apparatus

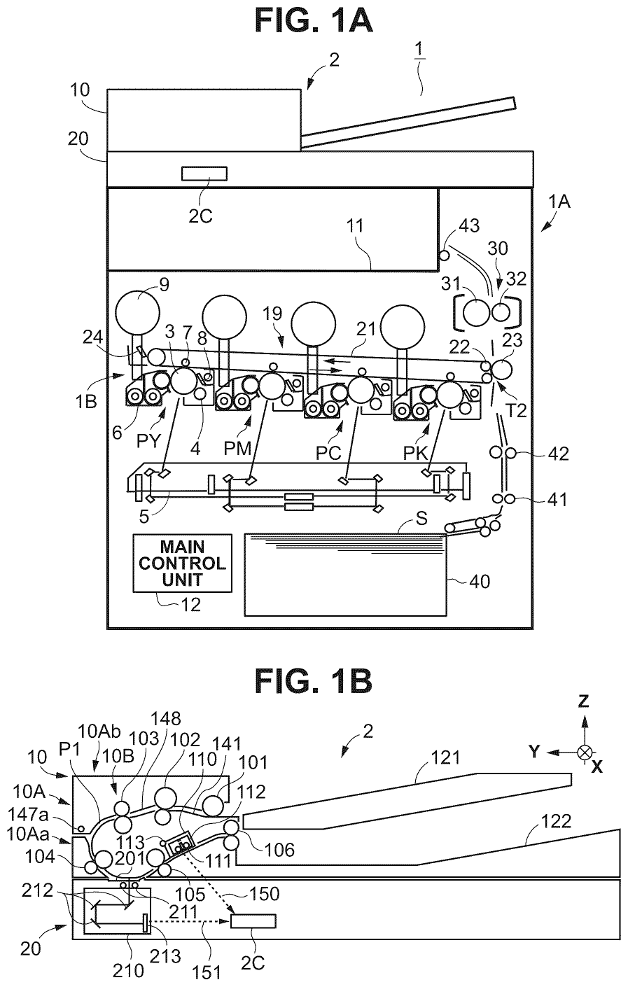

A schematic configuration of an image forming apparatus 1 according to an exemplary embodiment of the present disclosure will now be described with reference to FIG. 1A. The image forming apparatus 1 according to the present exemplary embodiment is a color electrophotographic apparatus including an image forming mechanism 1B including four image forming units PY, PM, PC, and PK serving as an image forming unit. The image forming apparatus 1 forms an image on a sheet S based on image information received from a document reading device 2 provided above an apparatus body 1A, or from an external apparatus. Since the sheet S is a recording medium, it is possible to use a variety of sheet materials different in size and material, including paper such as plain paper and thick paper, a plastic film, a cloth, and special-shaped sheet materials such as an envelope and index paper.

The image forming apparatus 1 includes a main control unit 12. The main control unit 12 includes a central processing unit (CPU) servings as a control program execution unit for the image forming apparatus 1, a read-only memory (ROM) for storing programs, a random access memory (RAM) for temporarily storing data, and an input/output circuit for inputting and outputting signals to and from an external apparatus. The CPU reads out programs from the ROM and executes the programs to send instructions to each unit of the image forming apparatus 1 via the input/output circuit, thereby controlling the operation of the image forming apparatus 1. For example, the main control unit 12 is electrically connected to a control unit 2C of the document reading device 2. The main control unit 12 is configured to receive image information read from a document by reading units 110 and 210 via the control unit 2C of the document reading device 2 and perform an image forming operation (copying) to form an image on the sheet S based on the received image information.

The image forming units PY, PM, PC, and PK form toner images of yellow, magenta, cyan, and black, respectively. The image forming units PY, PM, PC, and PK are also referred to as process units or image forming stations. The four image forming units PY, PM, PC, and PK have substantially the same configurations except for colors of toner used to form toner images. The image forming units PY, PM, PC, and PK each include a photosensitive drum 3 serving as an electrophotographic photosensitive member formed in a drum shape, a charging device 4 serving as a processing unit that acts on the photosensitive member and executes an electrophotographic process, a development device 6, and a drum cleaner 8. Below the image forming units PY, PM, PC, and PK, an exposure device 5 is located, serving as a process unit (exposure unit) for exposing the photosensitive drum 3 in each of the image forming units PY, PM, PC, and PK to light. Above each of the image forming units PY, PM, PC, and PK, a supply container 9 is provided for supplying developer to the development device 6 in each of the image forming units PY, PM, PC, and PK is detachably attached to the apparatus body 1A.

Above the image forming units PY, PM, PC, and PK, an intermediate transfer unit 19 is located. The intermediate transfer unit 19 includes an intermediate transfer belt 21 serving as an intermediate transfer member formed of an endless and flexible member, and a plurality of rollers around which the intermediate transfer belt 21 is stretched. The plurality of rollers includes an inner secondary transfer roller 22. On an outer peripheral side of the intermediate transfer belt 21, a secondary transfer roller 23 is located at a position opposing the inner secondary transfer roller 22 while sandwiching the intermediate transfer belt 21 therebetween. As a nip portion between the secondary transfer roller 23 and the inner secondary transfer roller 22, a transfer portion (secondary transfer portion T2) for transferring the image onto the sheet S from the intermediate transfer belt 21 is formed. On an inner peripheral side of the intermediate transfer belt 21, a primary transfer roller 7 is located at a position opposing the corresponding photosensitive drum 3 with the intermediate transfer belt 21 interposed therebetween. On the outer peripheral side of the intermediate transfer belt 21, a belt cleaner 24 is also located.

At a lower portion of the apparatus body 1A, a sheet feeding portion that feeds the sheet S is located. The sheet feeding portion includes a cassette 40 detachably attached to the apparatus body 1A, and a feeding unit that feeds the sheets S stacked and stored in the cassette 40 while separating the sheets S one by one. Conveyance rollers 41 and registration rollers 42 are located on a conveyance path leading from the sheet feeding portion to the secondary transfer portion T2.

A fixing device 30 is located downstream of the secondary transfer portion T2 in a sheet conveyance direction. The fixing device 30 includes a fixing roller 31 serving as a heating member, a pressing roller 32 serving as a pressing member, and a heating unit for heating the fixing roller 31. As the heating unit, a halogen lamp or an electromagnetic induction type heating unit can be used. Further downstream of the fixing device 30, a discharge roller 43 serving as a discharge unit for discharging the sheet S on which an image has been formed to the outside of the apparatus body 1A is located. An upper surface portion of the apparatus body 1A is provided with a discharge tray 11 serving as a stacking portion on which the sheet S on which an image has been formed is stacked. The present exemplary embodiment employs a so-called in-body discharge type configuration in which a space for discharging and stacking the sheets S on which an image has been formed is formed between the document reading device 2 and the apparatus body 1A in an up-down direction (vertical direction in a case where the image forming apparatus 1 is installed on a horizontal plane).

Upon receiving image information and an image forming operation execution instruction, the main control unit 12 executes the image forming operation as follows. The main control unit 12 starts rotation of the photosensitive drum 3 in each of the image forming units PY, PM, PC, and PK, and the charging device 4 performs charging processing to uniformly charge the surface of the photosensitive drum 3 to a predetermined polarity and potential. The exposure device 5 irradiates each photosensitive drum 3 with laser light modulated depending on an image signal (video signal) based on the image information, thereby writing electrostatic latent images corresponding to component images of yellow, magenta, cyan, and black color onto the surface of the photosensitive drum 3. The electrostatic latent images are developed by the development device 6 with developer containing toner of each color, so that yellow, magenta, cyan, and black toner images are formed on the surface of the photosensitive drum 3. The toner images carried on the surface of each photosensitive drum 3 are primarily transferred onto the intermediate transfer belt 21 from the photosensitive drum 3 by the primary transfer roller 7. In this case, the toner images of the respective colors are formed in a superimposed manner on the intermediate transfer belt 21, so that a full-color toner image is formed on the intermediate transfer belt 21. An adhering substance such as transfer residual toner remaining on the surface of the photosensitive drum 3 that is not transferred to the intermediate transfer belt 21 is removed by the drum cleaner 8. The image formed on the intermediate transfer belt 21 is conveyed to the secondary transfer portion T2 by the rotation of the intermediate transfer belt 21.

The sheets S are fed one by one from the cassette 40 in parallel with a toner image forming process in each of the image forming units PY, PM, PC, and PK, and are then conveyed to the registration rollers 42 via the conveyance rollers 41. After correcting skew of each sheet S, the registration rollers 42 convey the sheet S to the secondary transfer portion T2, such that the arrival of the image carried on the intermediate transfer belt 21 at the secondary transfer portion T2 is synchronized with the arrival of the sheet S at the secondary transfer portion T2. In the secondary transfer portion T2, a bias voltage is applied to the secondary transfer roller 23, to thereby transfer (secondarily transfer) the image onto the sheet S from the intermediate transfer belt 21. An adhering substance such as residual toner remaining on the surface of the intermediate transfer belt 21 without being transferred onto the sheet S is removed by the belt cleaner 24.

The sheet S that has passed through the secondary transfer portion T2 is conveyed to the fixing device 30. The fixing device 30 heats and presses the image on the sheet S while nipping and conveying the sheet S at a nip portion (fixing nip) between the fixing roller 31 and the pressing roller 32. As a result, the toner is melted and color-mixed and then is fixed, so that the image fixed onto the sheet S can be obtained. The sheet S having passed through the fixing device 30 is discharged by the discharge roller 43 and is stacked on the discharge tray 11. Thus, a series of image forming operations is finished.

While the present exemplary embodiment illustrates a configuration example of an intermediate transfer type color electrophotographic apparatus, the image forming apparatus 1 can also include a direct transfer type image forming unit that transfers toner images formed on an image carrying member to the sheet S without involving the intermediate transfer member. The image forming apparatus 1 can include not only an electrophotographic image forming unit, but also an inkjet printing unit or an offset printing mechanism as the image forming unit.

### Document Reading Device

The document reading device 2 that is an example of an image reading device will be described with reference to FIG. 1B. The document reading device 2 includes a scanner portion 20 (body portion, lower portion unit), and an ADF 10 serving as an upper portion unit that is provided above the scanner portion 20 and is rotatably supported by the scanner portion 20. The document reading device 2 is configured to execute an operation (fixed document reading operation) to read image information from a static document placed on a platen glass of the scanner portion 20 and an operation (document flow reading operation) to read image information while conveying each sheet S serving as a document with the ADF 10.

The scanner portion 20 includes the platen glass on which a document is placed, and the reading unit 210 that reads image information about the document placed on the platen glass while moving in a sub-scanning direction (left-right direction in FIG. 1B) below the platen glass. The scanner portion 20 also includes a glass 201 serving as a transparent member. The reading unit 210 is configured to optically scan the document conveyed by the ADF 10 via the glass 201, to read image information.

The reading unit 210 includes a sensor substrate 213 on which a charge-coupled device (CCD) image sensor serving as a light-receiving element is mounted, illumination portions 211 that irradiate the document with light, and a reduction optical system that includes a plurality of mirrors 212 and focuses reflected light from the document on an imaging plane of the light-receiving element. While the present exemplary embodiment illustrates the reading unit 210 of the CCD image sensor, the reading unit 210 can also include a contact image sensor (CIS) system configured to focus reflected light from the document on an imaging plane of a complementary metal oxide semiconductor (CMOS) image sensor opposed to the document via an equal-magnification optical system. The image information read by the reading unit 210 is transmitted to the control unit 2C via a signal line 151.

The ADF 10 includes a document tray 121, a discharge tray 122, an ADF body 10A serving as a conveyance unit in which a document conveyance path is formed, and the reading unit 110 located on the document conveyance path. The ADF body 10A is provided with a feed roller 101, a separation roller pair 102, conveyance roller pairs 103, 104, and 105, and a discharge roller pair 106 along the document conveyance path, serving as a conveyance portion 10B for conveying the sheets S. The document tray 121 is a stacking portion on which the sheets S are placed as documents from which information is to be read. The discharge tray 122 is a discharge portion for discharging the sheets S from which image the information has been read. The document tray 121 is located above the discharge tray 122, and the document conveyance path is curved in a U-shape that is open at one side thereof in a horizontal direction as viewed from a point of view of FIG. 1B (as viewed in a sheet width direction). The ADF body 10A includes a body portion 10Aa serving as a unit body of the conveyance unit, and an upper portion cover 10Ab serving as a cover unit that is rotatably supported with respect to the body portion 10Aa via a rotary shaft 147a.

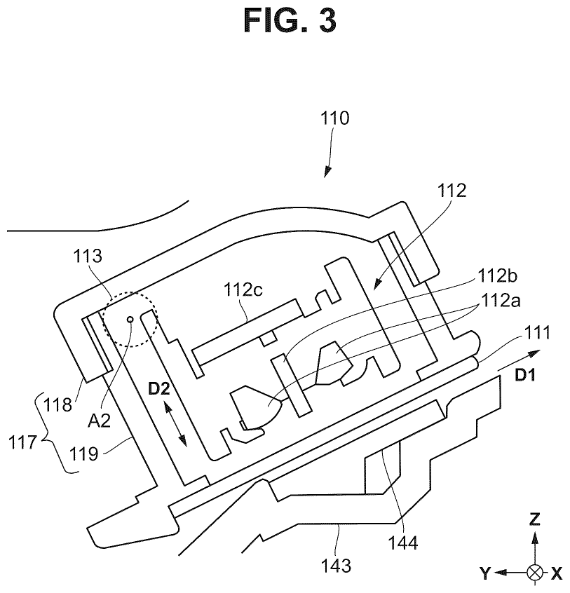

The reading unit 110 includes a CIS 112 serving as a reading portion, a holder member 117 that holds the CIS 112, and a glass 111 (also see FIG. 3). The glass 111 is a transparent member that is opposed to the document conveyance path (sheet conveyance path). The CIS 112 functions as the reading portion that reads, via the transparent member, image information from a document (sheet) conveyed along the document conveyance path.

The holder member 117 is a case formed in a substantially box shape with the longitudinal direction corresponding to a main scanning direction of the CIS 112. The holder member 117 and the glass 111 form a substantially rectangular parallelopiped-shaped space for accommodating the CIS 112. The CIS 112 includes a sensor substrate 112c on which a CMOS image sensor serving as a light-receiving element is mounted, an illumination portion 112a that irradiates the document with light, and a lens 112b that constitutes an equal-magnification optical system for focusing reflected light from the document on the imaging plane of the light-receiving element (see FIG. 3). While the present exemplary embodiment illustrates the reading unit 110 of the CIS system, an image sensor unit of a CCD image sensor may be used as the reading unit 110. The image information read by the reading unit 110 is transmitted to the control unit 2C via an electric wire 150.

A document conveyance operation to be performed by the ADF 10 will now be described with reference to FIG. 1B. When a user sets a bundle of documents on the document tray 121 and issues a reading operation start instruction via an operation portion, the documents are delivered from the document tray 121 by the feed roller 101, in an order from an uppermost document. The delivered documents are conveyed one by one by the separation roller pair 102 in a separated state, and are conveyed along the document conveyance path while being sequentially delivered to the conveyance roller pairs 103, 104, and 105 in this order.

When each document passes across the glass 201 of the scanner portion 20, image information on a first surface of the document is read by the reading unit 210. Similarly, when the document passes across the glass 111, image information on a second surface of the document is read by the CIS 112 of the reading unit 110. The document from which image information has been read is discharged to the outside of the ADF body 10A by the discharge roller pair 106 and is stacked on the discharge tray 122.

In the following description and the drawings, the vertical direction in a state where the image forming apparatus 1 is installed on the horizontal plane is referred to as a “Z-direction”. A sheet width direction perpendicular to the conveyance direction of the document to be conveyed along the document conveyance path is referred to as an “X-direction”. The X-direction corresponds to the main scanning direction during image reading and can be a direction (horizontal direction) perpendicular to the Z-direction. The horizontal direction when viewed in the X-direction is referred to as a “Y-direction”. The X-direction, the Y-direction, and the Z-direction are directions crossing each other and can be directions perpendicular to each other.

As described above, the ADF 10 includes the upper portion cover 10Ab that forms an upper surface portion of the ADF body 10A. The upper portion cover 10Ab is rotatably supported by the body portion 10Aa of the ADF body 10A via the rotary shaft 147a, and is rotatable about an axial line (third axis) extending in the X-direction. The upper portion cover 10Ab is provided with a conveyance guide 148 serving as an opposing guide (upper guide surface) that forms the document conveyance path between a guide surface (lower guide surface) of a rotation guide 141 supported by the body portion 10Aa. As illustrated in FIG. 1B, in a state where the upper portion cover 10Ab is closed, a part of the rotation guide 141 serving as a contacted member, a rotation member, or a second conveyance guide is covered with the upper portion cover 10Ab. In the state where the upper portion cover 10Ab is closed, the rotation guide 141 can be entirely covered with the upper portion cover 10Ab. The upper portion cover 10Ab is also provided with the feed roller 101, one (upper side in FIG. 1B) of the separation roller pair 102, and one (upper side in FIG. 1B) of the conveyance roller pair 103. Thus, when the upper portion cover 10Ab is rotated upward from a closed position (fifth position) illustrated in FIG. 1B, the upper portion cover 10Ab is located at an open position (sixth position). At the open position, a part of the document conveyance path is opened and the rotation guide 141 is exposed to the outside of the ADF 10, thereby bringing the rotation guide 141 into a rotatable state as described below.

### Glass Cleaning

Foreign matters including dust, such as paper powder, and contaminants such as paste (adhesive) and ink which have been deposited on the document may be present on the glasses 201 and 111 from the document reading device 2 repeatedly performing the document flow reading operation, in some cases. When the document flow reading operation is performed in a state where foreign matters are present on the glasses 201 and 111 within reading ranges of the reading units 210 and 110, stripe images that do not originally exist on the document are read at positions corresponding to the foreign matters. This phenomenon is caused by a shadow created by blocking an optical path during reading with the reading units 210 and 110, with the blocking being caused by foreign matters present on the glasses 201 and 111 (hereinafter, referred to as an “image stripe”)

To eliminate the occurrence of the image stripe, it is effective to remove the foreign matters, which cause the occurrence of the image stripe, through appropriate cleaning of the glasses 201 and 111. As regards the reading unit 210 of the scanner portion 20, the glass 201 of the reading unit 210 is exposed to the outside by rotating the ADF 10 upward from the scanner portion 20, so that the glass 201 can be cleaned from above. In contrast, the reading unit 110 of the ADF 10 is located within the ADF body 10A. As illustrated in FIG. 1B, in the present exemplary embodiment, the reading unit 110 is located on the inside area of the document conveyance path that is formed below the rotation guide 141 and is curved in a U-shape. For this reason, it may be necessary to provide a configuration for exposing the glass 111 to the outside (a unit for enabling access to the glass 111).

To expose the glass 111 of the reading unit 110 to the outside, the rotation guide 141 can be configured to support the reading unit 110 and the reading unit 110 can be rotated integrally with the rotation guide 141. In such a configuration, however, the reading unit 110 is rotated integrally with the rotation guide 141. Thus, when the rotation guide 141 abuts against another member, an impact may be generated, depending on the entire weight of a rotatable unit including the reading unit 110 and the rotation guide 141. The reading unit 110 is a precision device in which an electronic circuit including a light-receiving element, and optical elements constituting an illumination portion and an equal-magnification optical system or a reduction optical system are provided. For this reason, in a case where the rotation guide 141 is rotated to expose the glass 111 to the outside when a large impact force is applied to the reading unit 110, there is a possibility that internal components may be damaged or displaced.

Accordingly, as described below, the present exemplary embodiment employs a configuration in which the rotation guide 141 is provided as a rotatable rotation member or conveyance guide, and the reading unit 110 is configured to be rotatable independently of the rotation guide 141 about a rotational axis different from the rotational axis of the rotation guide 141. By rotating the rotation guide 141 and the reading unit 110, the glass 111 serving as the surface of the reading unit 110 that is opposed to the sheet S (object to be read) is exposed to the outside. In this case, since the reading unit 110 is not integrated with the rotation guide 141, the impact applied to the reading unit 110 when the reading unit 110 is moved to perform cleaning of the glass 111 or a jam clearance operation can be reduced.

### Structure of Reading Unit and Peripheral Portion

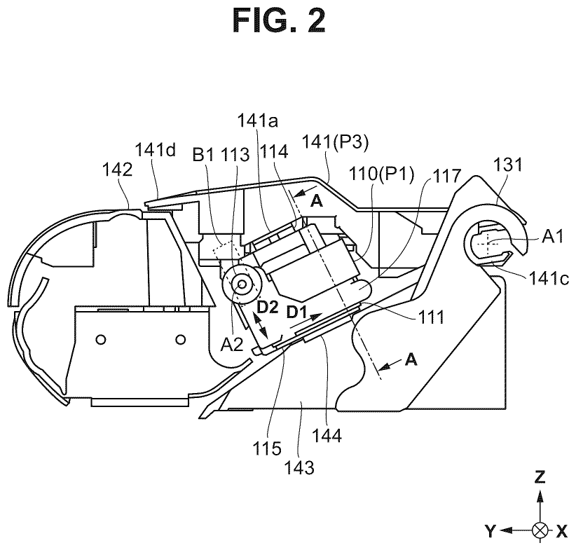

A specific configuration of the reading unit 110 and a peripheral portion thereof will be described with reference to FIGS. 2 to 6. FIG. 2 is a side view illustrating some components of the ADF 10. FIG. 2 illustrates members located on the inside of the document conveyance path, a base conveyance guide 143, and an arm 131 as viewed in the X-direction from the front side of the image forming apparatus 1. FIG. 3 is a sectional view of the reading unit 110 taken along a plane perpendicular to the X-direction.

As illustrated in FIG. 3, the reading unit 110 includes the holder member 117 that has a substantially U-shape in cross section so as to include the CIS 112, and has a configuration in which the glass 111 is attached to and covers an opening portion serving as a bottom portion. Specifically, the holder member 117 is composed of a reading frame 119 that covers and supports a side portion of the CIS 112, and a CIS cover 118 serving as a covering portion that covers the CIS 112 and is located on the opposite side of the glass 111 with respect to the CIS 112. Two gap sheets 115 serving as a first gap forming portion and a second gap forming portion, respectively, are attached to both ends of the glass 111 in the X-direction (longitudinal direction or main scanning direction of the CIS 112).

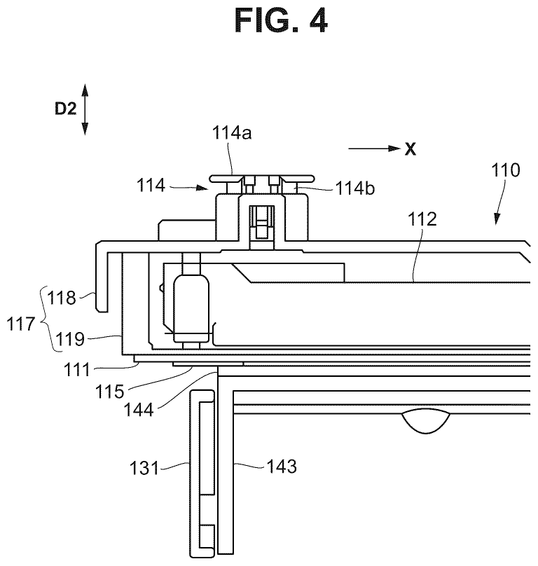

FIG. 4 is a cross sectional view taken along a line A-A illustrated in FIG. 2. The sectional view taken along the line A-A illustrates a cross-section of the reading unit 110 taken along a plane perpendicular to the sheet conveyance direction D1 at a scanning position of the reading unit 110 (a plane extending in the X-direction and a sheet thickness direction D2 at the scanning position). As illustrated in FIGS. 2, 4 and 10, the two gap sheets 115 attached to the both ends of the glass 111 in the X-direction abut against shading plates 144 serving as opposing members that are opposed to the glass 111. As a result, a gap corresponding to the thickness of the gap sheets 115 is provided between the glass 111 and the shading plates 144, as illustrated in FIG. 3 in an area (sheet passage area) between the gap sheets 115 in the X-direction. In other words, the gap sheets 115 each function as a gap forming member that contacts the opposing members that are opposed to the glass 111 and forms a gap between the glass 111 and the opposing members. Any member other than the gap sheets 115 can also be used, as long as the width of the gap is secured (defined). For example, a protrusion that protrudes toward the glass 111 can also be formed integrally with the reading frame 119.

The shading plates 144 are attached to the base conveyance guide 143 serving as a conveyance guide opposed to the glass 111 of the reading unit 110, and the base conveyance guide 143 is attached to a frame of the ADF 10. In other words, the shading plates 144 and the base conveyance guide 143 are members fixed as the body portion 10Aa of the ADF 10 and form an opposing guide for guiding each document to be conveyed.

Pressing portions 114 are also provided at two locations along the longitudinal direction to press the reading unit 110, so that the reading unit 110 is stably at rest at abutment positions of the gap sheets 115 (see FIGS. 4, 7 and 10). The pressing portions 114 are provided at an upper portion (surface that is opposite to the glass 111) of the reading unit 110. Each pressing portion 114 includes a resin cover 114a serving as a contact member that contacts a pressing surface 141a (FIG. 2) provided on a bottom surface of the rotation guide 141, and a compression spring 114b (FIG. 4) serving as an elastic member interposed between the resin cover 114a and the reading frame 119.

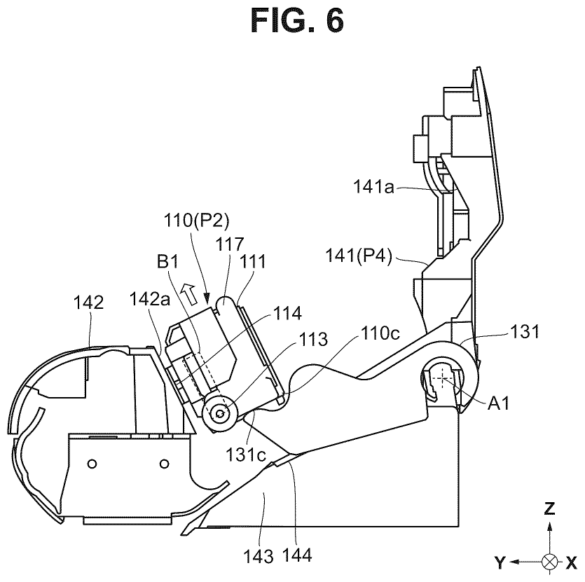

The rotation guide 141 includes a shaft portion 141c that is rotatably supported by the body portion 10Aa of the ADF 10. The rotation guide 141 is rotatable about a rotational axis A1 (second axis). In the present exemplary embodiment, the rotational axis A1 is provided at an upstream end (at an end on one side in the Y-direction) of the rotation guide 141 in the conveyance direction of the sheet S to be conveyed from the feed roller 101 to the separation roller pair 102. However, the rotational axis A1 can instead be provided at any other position. Any support portion other than the shaft portion 141c can also be provided as long as the support portion can rotatably support the rotation guide 141. The rotation guide 141 can be provided with a hole (bearing) so that a shaft shape provided on the body portion 10Aa of the ADF 10 can also be fitted to the rotation guide 141. The rotation guide 141 is rotatable between a position (hereinafter referred to as a closed position P3 as illustrated in FIG. 2) for guiding the lower surface of each document to be conveyed along the document conveyance path and a position (hereinafter referred to as an open position P4, illustrated in FIG. 6) that is shifted upward from the closed position P3. The closed position P3 is a position where the rotation guide 141 covers the reading unit 110 as viewed from above, and the open position P4 is a position (fourth position) where the rotation guide 141 exposes the reading unit 110 to the outside as viewed from above. The rotation guide 141 engages with a conveyance guide 142 serving as a third conveyance guide with a fixed portion 141d formed at a leading end thereof being fixed to the ADF body 10A, so that the rotation guide 141 is held at the closed position P3.

In a state where the rotation guide 141 is located at the closed position P3, the pressing surface 141a of the rotation guide 141 contacts the resin cover 114a of each pressing portion 114. An elastic force (urging force) of the compression spring 114b is generated when the resin cover 114a is pressed, and this elastic force presses the reading unit 110 against the shading plates 144. With this configuration, the position of the reading unit 110 in the sheet thickness direction D2 is stabilized, which contributes to highly accurate reading of image information.

The reading unit 110 includes a shaft portion 113 that is rotatably supported with respect to the body portion 10Aa of the ADF 10, and is rotatable about a rotational axis A2 (first axis) that is different from the rotational axis A1 of the rotation guide 141. Any support portion other than the shaft portion 113 can be used as long as the support portion can rotatably support the reading unit 110. The holder member 117 can be provided with a hole (bearing) so that a shaft shape provided on the body portion 10Aa of the ADF 10 can be fitted to the holder member 117. The reading unit 110 is rotatable (movable) between a position (hereinafter referred to as a reading position P1 as illustrated in FIG. 2) where image information can be read from the document to be conveyed along the document conveyance path and a position (hereinafter referred to as a maintenance position P2 as illustrated in FIG. 6) where the glass 111 is exposed to the outside. The reading position P1 is a position (first position) of the reading unit 110 in a state where the glass 111 serving as a transparent member is opposed to the document conveyance path. The maintenance position P2 is a position (second position) of the reading unit 110 in a state where the glass 111 is exposed to the outside as viewed from the outside of the ADF 10.

In a state where the reading unit 110 is located at the reading position P1, the glass 111 is opposed to the shading plates 144 or the base conveyance guide 143 with the document conveyance path interposed therebetween, and the glass 111 is hidden behind the holder member 117 as viewed from above in the vertical direction. The maintenance position P2 is a position of the reading unit 110 in a state where at least a part of the glass 111 (a range including the reading range of the CIS 110, or the entire glass 111) is exposed to the outside when the ADF 10 is viewed from a predetermined direction (for example, from above in the vertical direction).

The shaft portion 113 protrudes, for example, toward the outside in the X-direction from the both ends of the holder member 117 in the X-direction (longitudinal direction), and is held by a holding portion B1 that is provided on the body portion 10Aa of the ADF 10. The rotational axis A1 of the rotation guide 141 and the rotational axis of the reading unit 110 are therefore substantially parallel to each other and extend substantially in the X-direction. The holding portion B1 has a concave shape (opening portion) that rotatably holds the shaft portion 113. In the present exemplary embodiment, the holding portion B1 is an elongated circular hole (groove portion) extending in the sheet thickness direction D2. The holding portion B1 serving as the elongated circular hole is provided on, for example, a side plate (plate-like member expanding in the Y-direction and the Z-direction on the outside of the document passage area in the X-direction) that constitutes the frame of the body portion 10Aa of the ADF 10.

The rotational axis A1 of the rotation guide 141 is provided at an end on one side (right side in FIG. 2) in the Y-direction of the rotation guide 141, while the shaft portion 113 according to the present exemplary embodiment is provided at an end on the other side (left side in FIG. 2) in the Y-direction of the reading unit 110 and at an end on the upper side in the Z-direction. Accordingly, the reading unit 110 is rotated counterclockwise (in a first rotational direction) from the reading position P1 to the maintenance position P2, while the rotation guide 141 is rotated clockwise (in a second rotational direction) from the closed position P3 to the open position P4. The configuration in which the rotational direction of the rotation guide 141 is opposite to the rotational direction of the reading unit 110, as described above, allows the rotation range of the reading unit 110 to be secured without influence on the rotation guide 141 at the open position P4. The rotational direction when the rotation guide 141 is opened is opposite to the rotational direction when the upper portion cover 10Ab is opened.

### Schematic Configuration of Arm

The arm 131 is a member that is rotatably supported with respect to the body portion 10Aa of the ADF 10, and is rotated in conjunction with the rotation of the rotation guide 141 from the closed position P3 to the open position P4, thereby allowing the reading unit 110 to move from the reading position P1 to the maintenance position P2. In other words, the arm 131 is an example of an interlocking mechanism for allowing the reading unit 110 to move in conjunction with the rotation of the rotation guide 141. The arm 131 according to the present exemplary embodiment is a member that is rotated about the rotational axis A1 that is common to the rotation guide 141, and is rotatable independently of the rotation guide 141.

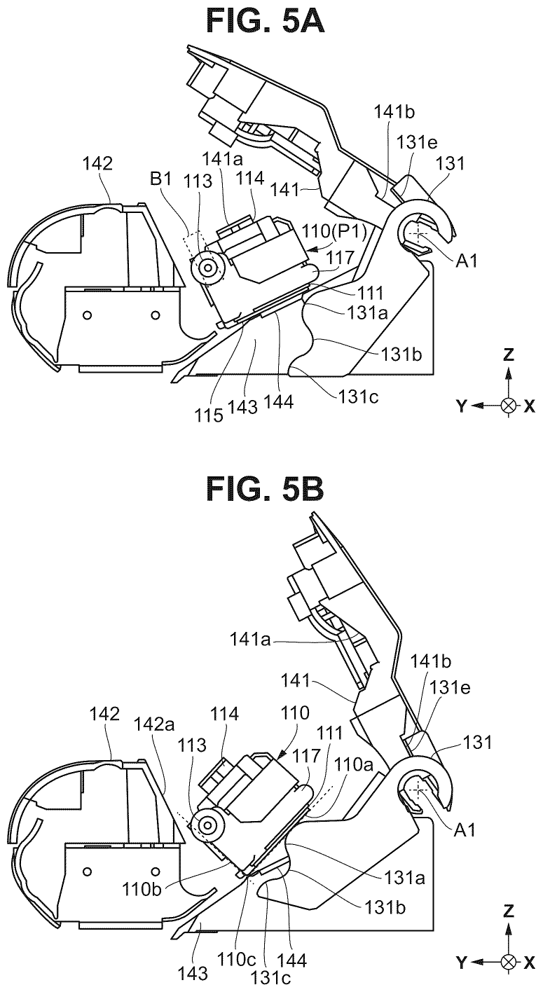

FIG. 5A illustrates a state where opening of the rotation guide 141 is started. FIG. 5B illustrates a state where opening of the reading unit 110 is started by opening the rotation guide 141. FIG. 6 illustrates a state where the reading unit 110 has moved to the maintenance position P2. As illustrated in FIGS. 5A and 5B, the rotation guide 141 is provided with an arm contact portion 141b, and the arm 131 is provided with a contacted portion 131e that is brought into contact with the arm contact portion 141b. In a state where the rotation guide 141 is located at the closed position P3 and the reading unit 110 is located at the reading position P1, the arm contact portion 141b is separated from the contacted portion 131e. At a leading end side of the arm 131, arc profiles 131a, 131b, and 131c are provided as contact portions to press the reading unit 110. The arc profiles 131a, 131b, and 131c will be described in detail below.

In the present exemplary embodiment, the arm 131 interlocks with the rotation guide 141 only within a certain range, and the rotation range of the arm 131 is narrower than the rotation range of the rotation guide 141. Specifically, the arm contact portion 141b of the rotation guide 141 does not contact the arm 131 at the closed position P3 of the rotation guide 141, and the arm contact portion 141b contacts the arm 131 during rotation of the rotation guide 141 toward the open position P4 (see FIG. 5B). For this reason, a rotation locus of the arm 131 is smaller than that in the case where the arm 131 is rotated integrally with the rotation guide 141, so that the arm 131 may be disposed in a small space.

### Movement of Reading Unit

An operation for moving the reading unit 110 from the reading position P1 to the maintenance position P2 during a maintenance operation will now be described. The following description is based on an operator (a user or a person in charge of maintenance operation) rotating the upper portion cover 10Ab to the open position from the closed position illustrated in FIGS. 1B and 2, to open the upper portion cover 10Ab.

In the state illustrated in FIG. 2, the operator puts his or her hand on the rotation guide 141 to rotate the rotation guide 141 clockwise in FIG. 5A about the rotational axis A1 so as to secure a space for rotation of the reading unit 110. Thus, as illustrated in FIG. 5A, the rotation guide 141 is upwardly separated from the reading unit 110 and the arm contact portion 141b approaches the contacted portion 131e of the arm 131.

When the rotation guide 141 is further rotated, the arm contact portion 141b contacts the contacted portion 131e of the arm 131, as illustrated in FIG. 5B, by further rotating the arm 131 clockwise about the rotational axis A1. When the arm 131 is rotated, the arc profiles 131a and 131c, which are provided at the leading end side of the arm 131, are brought into contact with and pressed against the reading unit 110, thereby rotating the reading unit 110 counterclockwise about the shaft portion 113.

As a result, the reading unit 110 moves from the reading position P1 illustrated in FIG. 2 to the maintenance position P2 illustrated in FIG. 6.

The operator can easily conduct an operation such as cleaning of the glass 111, once the reading unit 110 has been moved to the maintenance position P2. The rotation guide 141 is held at the open position P4 by its own weight, for example, so that the reading unit 110 can be held at the maintenance position P2 via the arm 131. When the reading unit 110 reaches the maintenance position P2, the pressing portions 114 of the reading unit 110 abut against an abutment surface 142a (FIG. 6) of the conveyance guide 142 fixed to the body portion 10Aa of the ADF body 10A. In this case, the elasticity of an elastic member (compression spring 114b) provided on each pressing portion 114 reduces an impact generated when the reading unit 110 abuts against the conveyance guide 142. In other words, the pressing portion 114 has not only a function of positioning the reading unit 110 during image reading, but also has a buffering function when the reading unit 110 is moved to the maintenance position P2.

After the operation such as cleaning of the glass 111 is finished, the operator rotates, in the state illustrated in FIG. 6, the rotation guide 141 counterclockwise from the open position P4 toward the closed position P3. As a result, the arm 131 is rotated counterclockwise in FIG. 6, following the rotation of the rotation guide 141. The reading unit 110 is also rotated clockwise in FIG. 6, from the maintenance position P2 toward the reading position P1 while being supported by the arm 131. When the rotation guide 141 reaches the closed position P3, the reading unit 110 then returns to the state illustrated in FIG. 2 in which the reading unit 110 is held at the reading position P1.

Specifically, in the present exemplary embodiment, the reading unit 110 moves from the reading position P1 to the maintenance position P2 in conjunction with the operation of opening the rotation guide 141, and the reading unit 110 moves from the maintenance position P2 to the reading position P1 in conjunction with the operation of closing the rotation guide 141.

As described above, the reading unit 110 is configured to be rotatable about a rotational axis different from that of the rotation guide 141, thereby reducing impact force that may be applied to the reading unit 110 when the reading unit 110 is moved to perform cleaning of the glass 111 or jam clearance.

In the present exemplary embodiment, the holding portion BI on a mating side (body portion 10Aa side of the ADF 10) of the shaft portion 113 of the reading unit 110 is configured as an elongated circular hole extending in the sheet thickness direction D2. To allow the reading unit 110 to be rotatable independently of the rotation guide 141, the holding portion B1 can be configured as a cylindrical hole corresponding to the shaft portion 113. However, in the present exemplary embodiment, the holding portion B1 is configured as an elongated circular hole, thereby allowing not only the rotation of the reading unit 110, but also the movement in the sheet thickness direction D2. With this configuration, variations in the position of the reading unit 110 due to a component tolerance or the like of the ADF 10 can be absorbed by the movement of the shaft portion 113 with respect to the holding portion B1, while a positional deviation of the reading unit 110 in the sheet conveyance direction D1 can be regulated. Since variations in the position of the reading unit 110 can be absorbed, the glass 111 can be stably positioned with respect to the shading plates 144 with the gap sheets 115 interposed therebetween.

As indicated by the arrow in FIG. 6, the reading unit 110 can be raised upward by the amount corresponding to the length of the holding portion B1 in a state where the reading unit 110 is rotated to the maintenance position P2, which leads to an improvement in workability of maintenance or the like. In this case, if the abutment surface 142a of the conveyance guide 142 is configured as an inclined surface with inclination along the holding portion B1, the abutment surface 142a can also function as a guide for raising the reading unit 110. In the present exemplary embodiment, the longitudinal direction of the elongated circular hole serving as the holding portion Bl substantially matches the sheet thickness direction D2 at the reading position P1 of the reading unit 110. The holding portion B1 is not limited to this configuration, but instead can be an elongated circular hole extending in a direction different from the sheet thickness direction D2 in the direction crossing the sheet conveyance direction D1 as viewed in the X-direction, as long as a positional deviation of the reading unit 110 in the sheet conveyance direction D1 at the reading position P1 can be regulated.

### Detailed Configuration of Arm

A configuration capable of improving the operability when the reading unit 110 is moved while the reading unit 110 can be rotated in a wide rotation range will be described.

The reading unit 110 has an orientation in which the glass 111 faces downward in the Z-direction at the reading position P1, and also has an orientation in which the glass 111 is exposed to the outside, as viewed from above in the Z-direction at the maintenance position P2. In other words, in the present exemplary embodiment, the transparent member faces downward in the vertical direction in a state where the reading unit 110 is located at the first position, and the transparent member faces upward in the vertical direction in a state where the reading unit 110 is located at the second position.

When a degree of inclination of the glass 111 at the reading position P1 relative to the horizontal direction is extremely large, a degree of flexure of the document conveyance path becomes large, which makes it difficult to convey thick paper or the like. For this reason, an angle of inclination of the glass 111 is set to, for example, 45 degrees or less, or 30 degrees or less. The reading unit 110 is therefore configured to be rotatable between the reading position P1 and the maintenance position P2 with a rotation range of, for example, 60 degrees or more, or 75 degrees or more, or 90 degrees or more.

In the case where the reading unit 110 is rotated in such a wide rotation range, in a configuration in which the operator directly puts his or her hand on the reading unit 110 to rotate the reading unit 110, the hand is more likely to be caught between the rotated reading unit 110 and another portion of the ADF 10, so that there is room for improvement in operability.

As described above, in the present exemplary embodiment, the leading end of the arm 131 that moves in conjunction with the rotation of the rotation guide 141 contacts the reading unit 110 from the lower side, thereby allowing the reading unit 110 to be rotated in conjunction with the rotation guide 141 (see FIGS. 5B and 6). In this case, the arm 131 is rotated in a rotational direction opposite to that of the reading unit 110, and the reading unit 110 is rotated from the reading position P1 to the maintenance position P2 while the contact position with respect to the reading unit 110 is changed. In this configuration, the reading unit 110 may be rotated in a wide rotation range, which leads to an improvement in operability. Further, the reading unit 110 can be moved from the reading position P1 to the maintenance position P2 with a minimum operating force, which leads to a reduction in operation load. This configuration will be described in detail below.

In the present exemplary embodiment, the arm 131 is provided with two contact portions (131a, 131c) and the two contact portions are sequentially brought into contact with and pressed against a first contact surface 110a and a second contact surface 110b of the reading unit 110.

Specifically, as illustrated in FIG. 5B, three arc profiles 131a, 131b, and 131c are provided at the leading end of the arm 131 according to the present exemplary embodiment. The three arc profiles are referred to as the first arc profile 131a, the second arc profile 131b, and the third arc profile 131c, respectively, in such order extending from the rotational axis A1 of the arm 131 to the outside, in the radial direction. The first arc profile 131a and the third arc profile 131c are arc-like curved surfaces that are convex toward the downstream side in the rotational direction (clockwise in FIG. 5B) of the arm 131 when the reading unit 110 is pressed. The first arc profile 131a is a first convex portion for pressing against the first contact surface 110a (first surface) of the reading unit 110. The third arc profile 131c is a second convex portion for pressing against the second contact surface 110b (second surface) of the reading unit 110. The second arc profile 131b is an arc-like curved surface that is recessed between the first arc profile 131a and the third arc profile 131c, and forms a space for receiving a corner portion 110c between the first contact surface 110a and the second contact surface 110b. In the present exemplary embodiment, the first contact surface 110a and the second contact surface 110b are adjacent surfaces (surfaces perpendicular to each other) of the reading unit 110 having a substantially rectangular shape in the X-direction. However, the first contact surface 110a and the second contact surface 110b are not limited to such examples. The first contact surface 110a and the second contact surface 110b can be the first surface and the second surface, respectively, that are surfaces extending in the directions crossing each other at an angle different from a right angle.

In the present exemplary embodiment, the first contact surface 110a of the reading unit 110 is a surface of the gap sheet 115 (gap forming member) attached to the glass 111. The arm 131 is prevented from directly contacting the glass 111, thereby reducing the possibility of damaging the glass 111. As illustrated in FIG. 4, a contact position of the arm 131 with the gap sheet 115 deviates from an abutment area of the shading plates 144 against the gap sheets 115 in the X-direction. Even when the surface of the first contact surface 110a of the gap sheet 115 to which the arm 131 is repetitively contacted is roughened, the accuracy of a gap width formed between the glass 111 and the shading plate 144 is thereby not lowered.

As illustrated in FIG. 5B, when the arm 131 is rotated in conjunction with the rotation of the rotation guide 141, the first arc profile 131a first contacts the first contact surface 110a of the reading unit 110, thereby allowing the reading unit 110 to start rotation from the reading position P1. In this case, the third arc profile 131c is not in contact with the second contact surface 110b of the reading unit 110.

When the arm 131 is further rotated and the angle of the reading unit 110 reaches a predetermined angle, the third arc profile 131c contacts the second contact surface 110b and the first arc profile 131a is separated from the first contact surface 110a. When the third arc profile 131c presses the second contact surface 110b, the reading unit 110 is then rotated to the maintenance position P2 as illustrated in FIG. 6.

The configuration in which the contact position between the arm 131 and the reading unit 110 is switched depending on the rotation angle of the reading unit 110 as described above makes it possible to rotate the reading unit 110 in a wide rotation range and reduce the operation load. Further, since the arc profile 131c having a concave shape is provided between the two convex portions of the arm 131 in contact with the first contact surface 110a and the second contact surface 110b of the reading unit 110, the two convex portions prevent the arm 131 and the reading unit 110 from being brought into a locked state. In other words, the corner portion 110c between the first contact surface 110a and the second contact surface 110b is accommodated in the space formed inside the arc profile 131c.

This configuration enables smooth transition from the contact state between the first arc profile 131a and the first contact surface 110a to the contact state between the third arc profile 131c and the second contact surface 110b.

Further, in the present exemplary embodiment, the three arc profiles 131a, 131b, and 131c are smoothly connected to each other (a tangential direction is not changed discontinuously). Thus, even when the contact position of the reading unit 110 is switched between the respective profiles, smooth rotation can be realized.

While the present exemplary embodiment described above illustrates a configuration example in which two convex portions and the recessed portion formed between the two convex portions are each formed of arc curves, two convex portions and the recessed portion formed between the two convex portions can also be formed of curves other than arc curves.

### Position of Pressing Portion in Longitudinal Direction

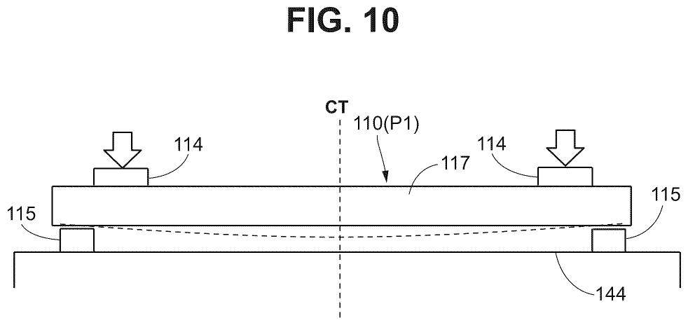

The position of each pressing portion 114 in the longitudinal direction will be described with reference to FIG. 10. FIG. 10 is a schematic view illustrating a state where the reading unit 110 located at the reading position P1 is pressed by the pressing portions 114.

As described above, the reading unit 110 is positioned by allowing the gap sheets 115 to abut against the shading plates 144 to obtain a positional relationship between the glass 111 and the shading plate 144 (see FIG. 2). The gap sheets 115 may be located on the outside of a width of a maximum size of a document to be conveyed in the main scanning direction so that the document can be conveyed. Thus, the size of the holder member 117 in the longitudinal direction may be greater than the width of the maximum size of the document, and the gap sheets 115 are located in the vicinity of the both ends of the holder member 117 in the main scanning direction.

In contrast, the holder member 117 of the reading unit 110 is provided with the pressing portions 114 on the opposite side of the glass 111. As illustrated in FIG. 10, the pressing force of the pressing portions 114 pressed by the rotation guide 141 (see FIG. 2) allows the reading unit 110 to be pressed against the shading plates 144.

In this case, if pressing portions are located, for example, inside the pressing portions 114 illustrated in FIG. 10 in the longitudinal direction (main scanning direction of the CIS 112), a bending moment that causes the holder member 117 of the reading unit 110 to be deflected as indicated by a dashed line in FIG. 10 increases. Specifically, the bending moment generated in the holder member 117 of the reading unit 110 decreases as the distance between the gap sheet 115 and the pressing portion 114 in the longitudinal direction decreases, and the position accuracy of the glass 111 increases as the bending moment decreases. Although each document is conveyed by being guided to the surface of the glass 111, the CIS 112 typically has a narrow depth of field, so that an out-of-focus area may be generated due to degradation in the position accuracy on the surface of the glass 111. For this reason, a separate pressing portion 114 may be disposed in the vicinity of each end of the holder member 117 in the main scanning direction.

In the present exemplary embodiment, as illustrated in FIG. 10, one of the pressing portions 114 is located closer to the gap sheet 115 located on the same side with respect to a center CT of the holder member 117 in the longitudinal direction than the center CT in a state where the reading unit 110 is located at the reading position P1. Similarly, the other of the pressing portions 114 is also located closer to the gap sheet 115 located on the same side with respect to the center CT of the holder member 117 in the longitudinal direction than the center CT. In other words, each pressing portion of the two pressing portions 114 is respectively located in the vicinity of a respective end of the holder member 117, adjacent to a respective gap sheet 115 in the longitudinal direction, as viewed in the direction perpendicular to the surface of the glass 111.

A case where the glass 111 is cleaned as described above will now be considered. In the case of cleaning the glass 111, the reading unit 110 is rotated to the maintenance position P2 and the pressing portions 114 are positioned by allowing the pressing portions 114 to abut against the abutment surface 142a of the conveyance guide 142 (see FIG. 6). Each pressing portion 114 that includes the compression spring 114b functions as a damper for the compression spring 114b to reduce the impact even when the user swiftly rotates the reading unit 110, thereby making it possible to protect the CIS 112. However, when the user cleans the glass 111 in this state, the pressing portions 114 are located in the vicinity of the both ends of the holder member 117 in the longitudinal direction, and thus there is a possibility that the reading unit 110 can be excessively deformed due to the pressing force (operating force) received only by the pressing portions 114 during cleaning. In particular, plastic deformation (permanent deformation) may occur depending on the magnitude of the pressing force. In this case, degradation of the quality of an image read from a document, or a failure such as a reading operation failure may occur in some cases. Thus, the present exemplary embodiment provides backup portions, as described below, so as to solve this issue.

### Backup Portions

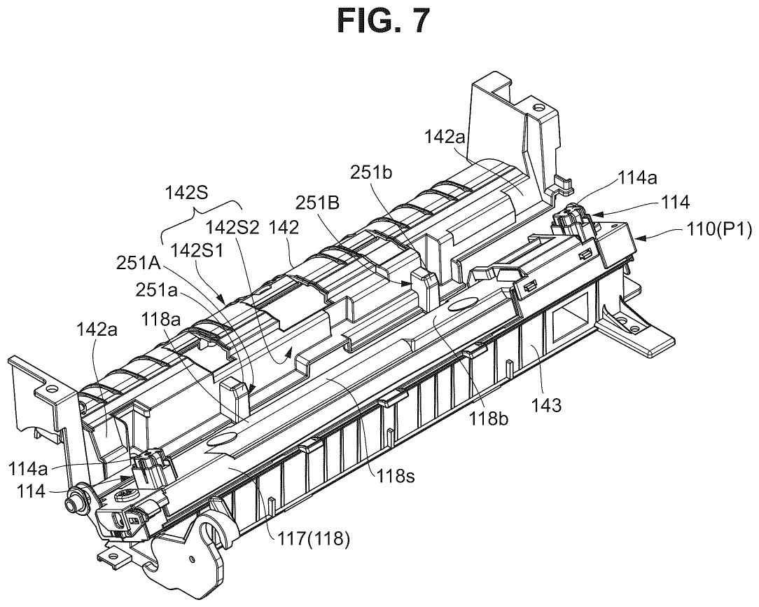

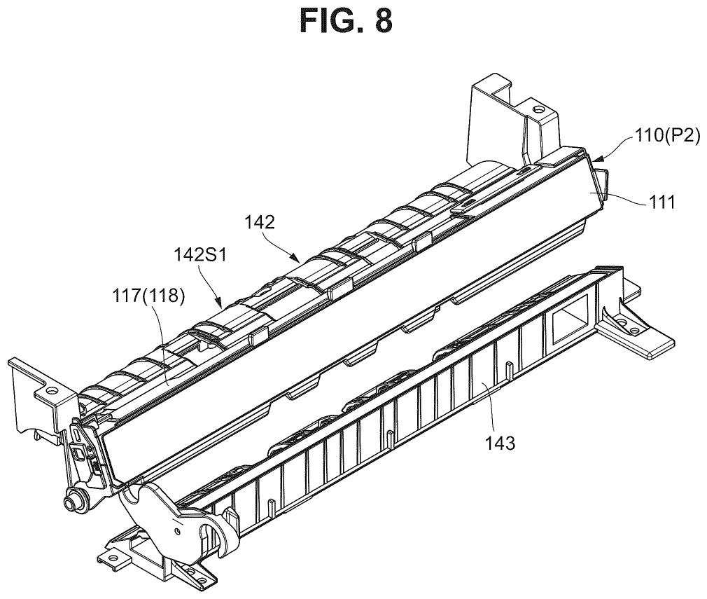

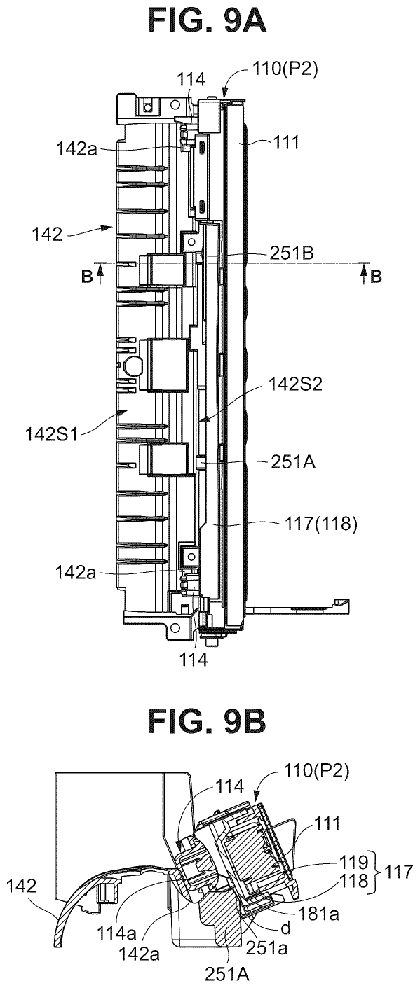

A configuration example of backup portions each serving as a holder support portion according to the present exemplary embodiment will be described with reference to FIGS. 7 to 9B. FIG. 7 is a perspective view illustrating the conveyance guide 142 of the apparatus body 1A and the reading unit 110 located at the reading position P1. FIG. 8 is a perspective view illustrating the conveyance guide 142 of the apparatus body 1A and the reading unit 110 located at the maintenance position P2. FIG. 9A is a top view illustrating the conveyance guide 142 of the apparatus body 1A and the reading unit 110 located at the maintenance position P2. FIG. 9B is a cross sectional view taken along a line B-B illustrated in FIG. 9A.

As illustrated in FIG. 7, the conveyance guide 142 has an outer peripheral surface 142S formed on the outside thereof. The outer peripheral surface 142S includes a guide area 142S1 that guides each sheet S, and a non-guide area 142S2 that does not guide each sheet S (sheet S is not in contact with the non-guide area 142S2). The guide area 142S1 forms the document conveyance path with the conveyance guide 148 of the upper portion cover 10Ab described above. The non-guide area 142S2 corresponds to an outer surface portion extending downward from the document conveyance path. In the vicinity of the both ends of the non-guide area 142S2 in the longitudinal direction, two abutment surfaces 142a against which the resin covers 114a of the pressing portions 114 described above abut (contact) are formed. Two backup portions 251A and 251B are formed between the two abutment surfaces 142a in the longitudinal direction. Specifically, the backup portions 251A and 251B are located between the pressing portions 114 in the longitudinal direction in a state where the reading unit 110 is located at the maintenance position P2 as illustrated in FIGS. 8 and 9A.

As illustrated in FIG. 7, the backup portions 251A and 251B are provided with contact surfaces 251a and 251b that can be brought into contact with contacted portion 118a and 118b, respectively, on an upper surface 118s of the CIS cover 118 of the holder member 117. The contact surfaces 251a and 251b of the backup portions 251A and 251B and the contacted portions 118a and 118b of the CIS cover 118 of the holder member 117 include a gap d in a state where the reading unit 110 is located at the maintenance position P2, as illustrated in FIG. 9B. That is, the contact surfaces 251a and 251b and the CIS cover 118 of the holder member 117 are separated in a state where the reading unit 110 is located at the maintenance position P2. In other words, the pressing portions 114 contact the reading unit 110 when the reading unit 110 is moved to the maintenance position P2. Thus, when the reading unit 110 is moved to the maintenance position P2, the impact applied to the CIS 112 can be reduced by the pressing portions 114, thereby preventing the holder member 117 and the backup portions 251A and 251B from colliding with each other and making it possible to protect the CIS 112.

For example, assume that the user or service person has moved the reading unit 110 to the maintenance position P2 and has pressed against the glass 111 when the glass 111 is cleaned. In this case, the contact surfaces 251a and 251b of the backup portions 251A and 251B contact the contacted portions 118a and 118b of the CIS cover 118 of the holder member 117, so that the holder member 117 is supported by the backup portions 251A and 251B. That is, the backup portions 251A and 251B are configured to support the holder member 117. Consequently, while cleaning the glass 111, excessive deformation of the reading unit 110 due to the pressing force (load) caused by the cleaning can be prevented and the risk of occurrence of plastic deformation can be reduced.

### Other Exemplary Embodiments

While the present exemplary embodiment described above illustrates a configuration example including the two backup portions 251A and 251B, the present exemplary embodiment is not limited to this example. For example, a single backup portion having an elongated shape continuously formed in the longitudinal direction can also be used, or three or more backup portions can be arranged and located in the longitudinal direction.

The present exemplary embodiment described above illustrates a configuration example in which the backup portions 251A and 251B are provided on the conveyance guide 142 in the body portion 10Aa of the ADF body 10A. However, the present exemplary embodiment is not limited to this example. The backup portions 251A and 251B can also be provided on the CIS cover 118 of the holder member 117.

Specifically, the backup portions 251A and 251B can be provided on one of the CIS cover 118 and the ADF body 10A, and can contact the other of the CIS cover 118 and the ADF body 10A at lease when the glass 111 is pressed. In other words, the exemplary embodiment described above illustrates a configuration example in which the backup portions 251A and 251B are convex from the conveyance guide 142, and the contacted portions 118a and 118b of the CIS cover 118 are flat. On the contrary, the backup portions 251A and 251B each having a convex shape can be provided on the CIS cover 118 and flat portions of the conveyance guide 142 can also be formed as the contacted portions 118a and 118b.

The present exemplary embodiment described above illustrates a configuration example in which the pressing portions 114 each include the compression spring 114b and the reading unit 110 is pressed against the shading plates 144 via the gap sheets 115. However, the present exemplary embodiment is not limited to this example. The pressing portions 114 can also be configured to protrude in a convex shape from the CIS cover 118, and may not be configured to press the reading unit 110. In this case, the conveyance guide 142 can also be provided with an elastic member to reduce an impact when the reading unit 110 abuts against the conveyance guide 142 when the reading unit 110 is moved to the maintenance position P2.

The present exemplary embodiment described above illustrates a configuration example in which the reading unit 110 and the rotation guide 141 are rotated separately, thereby reducing the impact exerted when the reading unit 110 abuts against the conveyance guide 142. However, the present exemplary embodiment is not limited to this example. The reading unit 110 and the rotation guide 141 can also be integrally formed. In this case, the buffering effect of the compression spring 114b of the pressing portion 114 can be set to a high level, or another elastic member can also be placed.

The present exemplary embodiment described above illustrates a configuration example in which the reading unit 110 is caused to abut against (contact) the conveyance guide 142 when the reading unit 110 is moved to the maintenance position P2. However, the present exemplary embodiment is not limited to this example. At the maintenance position P2, the reading unit 110 can also be caused to abut against another member in the body portion 10Aa of the ADF body 10A. In this case, the other member may be provided with a backup portion.

The present exemplary embodiment described above illustrates a configuration example in which the gap d is formed between the CIS cover 118 and the backup portions 251A and 251B when the reading unit 110 is moved to the maintenance position P2 and the CIS cover 118 and the backup portions 251A and 251B contact each other when the glass 111 is pressed. However, the present exemplary embodiment is not limited to this example. The pressing portions 114 and the backup portions 251A and 251B can contact the CIS cover 118 at the same time when the reading unit 110 is moved to the maintenance position P2. Moreover, when the reading unit 110 is moved to the maintenance position P2, the backup portions 251A and 251B can contact the CIS cover 118 earlier than the pressing portions 114. In particular, the backup portions 251A and 251B can be configured such that an elastic member such as a rubber sheet is attached to the contact surfaces 251a and 251b so that the component tolerance can be compensated while interfering with the impact when the reading unit 110 is moved to the maintenance position P2. In other words, even when the pressing portions 114 are not in contact with the body portion 10Aa, and when the backup portions 251A and 251B are in contact with the CIS cover 118, the pressing force during cleaning can be supported by the backup portions 251A and 251B, which leads to a reduction in deformation of the reading unit 110. Accordingly, the provision of the backup portions 251A and 251B that are in contact with the covering portion between the two pressing portions 114 in a state where the reading unit 110 is located at the maintenance position P2 makes it possible to obtain effects similar to those of the present exemplary embodiment.

The present exemplary embodiment described above illustrates a configuration example in which the gap sheets 115 are attached to the reading unit 110 (both ends of the glass 111). However, the present exemplary embodiment is not limited to this example. The gap sheets 115 can also be attached to the shading plates 144.

While the present exemplary embodiment described above illustrates a configuration example in which the document reading device 2 of the image forming apparatus 1 is used as an example of the image reading device, the present exemplary embodiment is not limited to this example. For example, any apparatus such as a scanner apparatus can also be used as long as the apparatus functions as an image reading device for reading an image on a sheet (document).

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-128670, filed Aug. 5, 2024, which is hereby incorporated by reference herein in its entirety.

What is claimed is:

1. An image reading device comprising:
a conveyance unit including a conveyance roller configured to convey a sheet; and
a reading unit including a transparent member, a sensor configured to read an image on the sheet conveyed by the conveyance roller via the transparent member, a case configured to accommodate the sensor, and a first contact portion and a second contact portion that are located at the case,
wherein the reading unit is movable to each of a first position and a second position, wherein the image on the sheet is read by the sensor with reading unit in the first position, and wherein the transparent member is exposed to an outside and the first contact portion and the second contact portion contact the conveyance unit with the reading unit in the second position,
wherein one of the case and the conveyance unit is provided with a backup portion located between the first contact portion and the second contact portion in a longitudinal direction of the case, and
wherein, in a case where the transparent member is pressed in a state where the reading unit is located at the second position, the backup portion contacts the other of the case and the conveyance unit so that the conveyance unit supports the case.

2. The image reading device according to claim 1, wherein the first contact portion and the second contact portion protrude from a surface of the case at an opposite side of the transparent member.

3. The image reading device according to claim 2, wherein the first contact portion and the second contact portion include a first spring and a second spring, respectively, the first spring and the second spring being configured to press against the case in the state where the reading unit is located at the first position.

4. The image reading device according to claim 1,
wherein the conveyance unit includes a conveyance guide and an opposing guide configured to guide the sheet conveyed by the conveyance roller,
wherein the opposing guide is provided opposed to the transparent member of the reading unit located at the first position,
wherein one of the reading unit and the opposing guide includes a first gap forming portion and a second gap forming portion, the first gap forming portion and the second gap forming portion each forming a gap between the opposing guide and the transparent member of the reading unit located at the first position and being located outside a passage area for the sheet conveyed by the conveyance roller, and
wherein the first contact portion and the second contact portion are respectively located at positions closer to a center of the case in the longitudinal direction than the first gap forming portion and the second gap forming portion.

5. The image reading device according to claim 3,
wherein the reading unit is configured to rotate to the first position and the second position about a first axis with respect to the conveyance unit,
wherein the conveyance unit includes a unit body, and a rotation member configured to rotate to a third position and a fourth position about a second axis parallel to the first axis with respect to the unit body, the third position being a position where the reading unit located at the first position is covered, the fourth position being a position where the reading unit is exposed to an outside, and
wherein the first contact portion and the second contact portion are brought into contact with the rotation member located at the third position to press the case in a state where the reading unit is located at the first position.

6. The image reading device according to claim 5, wherein the conveyance unit includes a cover unit forming an upper surface of the image reading device, the cover unit being configured to rotate to a fifth position and a sixth position about a third axis parallel to the first axis with respect to the unit body, the fifth position being a position where the rotation member located at the third position is covered, the sixth position being a position where the rotation member is exposed to an outside.

7. The image reading device according to claim 1, wherein the backup portion is provided on the conveyance unit.

8. The image reading device according to claim 7,
wherein the conveyance unit includes a conveyance guide configured to guide the sheet conveyed by the conveyance roller, the conveyance guide including a guide area configured to guide the sheet to the outside, and a non-guide area,
wherein the non-guide area includes a first contacted portion configured to contact the first contact portion, a second contacted portion configured to contact the second contact portion, and
wherein the backup portion is located between the first contacted portion and the second contacted portion.

9. The image reading device according to claim 1, wherein a plurality of the backup portions are formed in the longitudinal direction.

10. The image reading device according to claim 1, wherein, in a case where the transparent member is not pressed in the state where the reading unit is located at the second position, the backup portion is separated from the other of the case and the conveyance unit.

11. An image forming apparatus comprising:
a conveyance unit including a conveyance roller configured to convey a sheet;
a reading unit including a transparent member, a sensor configured to read an image on the sheet conveyed by the conveyance roller via the transparent member, a case configured to accommodate the sensor, and a first contact portion and a second contact portion that are located at the case; and
an image forming unit configured to form an image on a recording medium based on image information read by the reading unit,
wherein the reading unit is movable to each of a first position and a second position, wherein the image on the sheet is read by the sensor with the reading unit in the first position, and wherein the transparent member is exposed to an outside and the first contact portion and the second contact portion contact the conveyance unit with the reading unit in the second position,
wherein one of the case and the conveyance unit is provided with a backup portion located between the first contact portion and the second contact portion in a longitudinal direction of the case, and
wherein, in a case where the transparent member is pressed in a state where the reading unit is located at the second position, the backup portion contacts the other of the case and the conveyance unit so that the conveyance unit supports the case.
